(19) United States
(12) Patent Application Publication
(10) Pub. No.: US 2009/0186136 A1
(43) Pub. Date: Jul. 23, 2009

(54) PROCESS FOR SEED AND GRAIN FRACTIONATION AND RECOVERY OF BIO-PRODUCTS

(75) Inventors: Nienke LINDEBOOM, Saskatchewan (CA); Philip J. Leduc, Saskatchewan (CA); Paul G. Arnison, Saskatchewan (CA)

Correspondence Address: SUGHRUE MION, PLLC, 2100 PENNSYLVANIA AVENUE, N.W., SUITE 800, WASHINGTON, DC, 20037, US

(73) Assignee: Saponin Inc., Saskatoon (CA)

(21) Appl. No.: 12/016,931

(22) Filed: Jan. 18, 2008

(51) Int. Cl. A23L 1/00; A23J 1/14

(52) U.S. Cl. 426/430

(57) ABSTRACT

The present invention describes the fractionation and processing of seed of Saponaria vaccaria L, a species that can be grown on a large scale using conventional agricultural practices. The main products recovered are an extremely fine starch (0.5-1.5 μm) and a plant extract comprising saponins, cyclopeptides and phenolic compounds.

### FIELD OF INVENTION

The present invention relates to the field of seed and grain processing.

### BACKGROUND OF THE INVENTION

Procedures for the milling and fractionation of seed and grain are well established for major crop plants. However, development of comprehensive milling and fractionation procedures for a new species may be challenging and established procedures inappropriate. Seed fractionation and grinding can be accomplished by conventional dry milling, wet milling, or a combination of both dry and wet milling. Milling can separate the constituents of the seeds or grains, including the starch body (endosperm or perisperm minus the aleurone layer), the germ, the aleurone layer, and hull layer. The last two layers are often classified as bran. Typically, separation is based on the differences in hardness, density and water absorption capacity of the different constituents. Milling may also be used to reduce the particle size of the material to facilitate further processing.

Dry milling seed and grain is well known and may include disk milling (U.S. Pat. No. 4,667,888; U.S. Pat. No. 4,674,689), roller milling (U.S. Pat. No. 5,165,608; U.S. Pat. No. 5,100,062, U.S. Pat. No. 5,089,282), abrasion milling (similar in action to polishing and pearling; U.S. Pat. No. 5,511,469; U.S. Pat. No. 5,390,589; U.S. Pat. No. 5,104,671), and impact milling (U.S. Pat. No. 5,020,732; U.S. Pat. No. 4,301,183; U.S. Pat. No. 3,979,375; U.S. Pat. No. 5,873,301). These milling methods are often used in combination, for example grain pearling prior to roller milling (U.S. Pat. No. 5,390,589).

A tempering step may be used to selectively soften the grain and facilitate the milling and fractionation process. Tempering is generally done by addition of water with or without heating and with or without specific chemicals to increase the effect of tempering and decrease the tempering time. Tempering can also be accomplished by redistributing the water within the kernel by bringing the grain or seed to its glass transition temperature (U.S. Pat. No. 6,887,509).

Starch production is often based on the combination of dry and wet milling followed by a wet processing step to separate the starch from the protein, fiber and oil, and to recover the starch and proteins. Important considerations are effective deproteinization of the starch, minimizing the loss of the small starch granules, avoidance of starch gelatinization and avoidance of amylolytic or mechanical damage to the starch granules that would result in a reduced starch yield.

Major sources of refined starch are corn, wheat and potato. Most commercial corn starch production is based on a wet milling process. However, processes based on wet-milling solely are often disadvantageous because of the need of long steeping times, large amounts of process water and expensive milling equipment. Therefore, processes involving dry milling followed by wet milling have been developed (U.S. Pat. No. 4,171,384; U.S. Pat. No. 4,181,748).

A number of processes for wheat starch production make use of the capability of wheat protein (i.e. gluten) to form a tight network from which the starch can be easily removed by washing (e.g. the “dough ball process”, where starch is washed out of the dough with water; Knight et al 1984). Saponaria vaccaria L does not form such protein or gluten network.

The Fresca process for wheat fractionation does not take advantage of the gluten network. Instead, the grain is dry milled after which the flour is dispersed in water, while shearing to prevent gluten network formation, followed by centrifugation of this dispersion, which results in a starch rich pellet and a supernatant containing soluble protein (Knight et al 1984). One of the shortcomings of this process is that the decanters and hydro cyclones used for the centrifugation are not very efficient in separating particles smaller than 5 μm. Wheat starch has a bimodal starch granule size distribution, whereby 70% (by weight) of the starch granules have a diameter of 10-35 μm and approximately 30% are smaller than 10 μm (Lindeboom et al 2004). A large number of small granules, together with a portion of the damaged starch granules, appear in the overflow of the hydro cyclones and are lost (Esch 1991).

Rice starch is a major commercially available small granule starch and has a starch granule size of 5 μm. However, a starch granule size of 5 μm is much larger than that of Saponaria vaccaria. The process employed for rice starch production consists of steeping rice in a dilute sodium hydroxide solution, milling the slurry, removing the cell wall (fiber) by screening, extracting the protein with sodium hydroxide solution, and recovering the starch by centrifugation followed by washing and drying (Juliano 1984).

The soapwort, Saponaria vaccaria L., (also known as Vaccaria segetalis, Vaccaria hispanica; cow cockle, cowherb, China cockle, or spring cockle) is a member of the Pink (Caryophyllaceae) family. This plant was studied previously as a starch source and alternative crop by Goering et al (1965) and Mazza et al (1992). Whole mature Saponaria vaccaria seeds are black, round and approximately 2.5 mm in diameter. Saponaria vaccaria seed consists of a pigmented fibrous outer seed coat or hull, a germ or embryo and a perisperm. The seed coat or hull is black and adheres tightly to the perisperm and loosely to the germ.

In contrast to cereals, the Saponaria vaccaria germ is positioned on the periphery of the seed and nearly encircles the starchy perisperm. The Saponaria vaccaria germ contains protein and oil as well as secondary plant metabolites such as saponins (sapogenins), cyclopeptides (segetalins) and phenolics (primarily vaccarin). The perisperm is largely comprised of starch and protein. The starch containing perisperm originates from nucellar tissues and not from tissues derived form the fertilization process. As such the starch that is formed is maternal in origin and not derived from the embryo. Mature Saponaria vaccaria seed does not have an endosperm.

Saponaria vaccaria seed contains approximately 55% starch, approximately 13% fiber, approximately 12% protein comprising an amino acid composition that is nutritionally balanced and suitable for both human food and animal feed products, approximately 9% moisture, approximately 3.5% lipids, approximately 3% saponins, which are concentrated in the seed hull and germ, approximately 0.4% phenolic compounds and approximately 0.2% cyclopeptides (also known as segetalins; Morita et al 2006). The major components of the lipid fraction are triglycerides. The fatty acid composition is similar to that of cereals, with the major fatty acids comprising linoleic acid (42.6%), oleic acid (36.7%) and palmitic acid (12.7%).

Saponins are glycosides of steroids, steroid alkaloids (steroids with nitrogen comprising part of the structure) or triterpenes that are found in plants as secondary plant metabolites. Saponins from Saponaria vaccaria are structurally similar to triterpenoid saponins from other species such as Quillaja (Quillaja saponaria, the soapbark tree). Saponins have a wide range of human health care, therapeutic and medicinal applications (Francis et al 2002; Sparg et al 2004). For example, some saponins have immune-stimulatory properties and can be used in the formulation of vaccine adjuvants (U.S. Pat. No. 5,977,081; U.S. Pat. No. 6,080,725; Oda et al 2004). Saponins may be used in cosmetic and personal care applications, (e.g. U.S. Pat. No. 4,800,080; U.S. Pat. No. 5,086,045; U.S. Pat. No. 5,166,139; U.S. Pat. No. 5,663,160; U.S. Pat. No. 5,770,223; U.S. Pat. No. 5,723,149; U.S. Pat. No. 6,475,536; U.S. Pat. No. 6,641,848) including creams and lotions that are targeted to skin aesthetics, skin rejuvenation, treatment of certain skin ailments. They can also enhance the physical properties of the creams and lotions as well as that they can be used in hair care products with specific functionality. Examples of agricultural applications of saponins include activity against fungi (U.S. Pat. No. 6,310,091), bacteria (U.S. Pat. No. 6,743,752) and nematodes (U.S. Pat. No. 5,595,748).

The starch granule obtained from Saponaria vaccaria is polygonal in shape with a diameter less than 1.5 μm (Biliaderis et al 1993). This is the smallest granule starch known in the plant kingdom. (Lindeboom et al 2004). The starch contains 12% amylose (determined according to Demeke et al 1999). The intact granules have an A-type X-ray diffraction pattern, a melting peak temperature of 68° C. and a gelatinization enthalpy of around 12 J/g. The starch shows similar viscosity, swelling and solubility profiles to those of rice starch. Saponaria vaccaria starch is very susceptible to α-amylolysis, presumably because of the small granule size (Biliaderis et al 1993).

The small granule size makes Saponaria vaccaria starch difficult to purify. However, the small granule size also makes the starch suitable for very specific applications such as in specialty paper and printing, in biodegradable films and plastics, as binder of orally active ingredients, as carrier for cosmetic ingredient and a diverse range of compounds, as agent to improve textural properties and skin-feel of cosmetics and personal care products and as fat replacer in foods.

Saponaria vaccaria starch has been produced by a wet milling technique that comprised steeping seed for 45 hr at 48-50° C. in 0.15N lactic acid, followed by milling (Quaker City Drug Mill) with subsequent screening to remove the dark colored hull. Several screening and centrifugation steps were needed to obtain the final starch product (Goering et al 1965).

A wet milling process for starch production from Saponaria vaccaria is described in U.S. Pat. No. 3,622,389. The process is based on dehulled and degermed Saponaria vaccaria seed that is prepared by conventional wet milling or less preferably by dry milling techniques. No details are provided describing the way in which this dehulling and degerming was accomplished. The process as described is time consuming due to long steeping times and uses large volumes of aqueous media. No mention is made of problems associated with saponins and associated foaming during processing, or saponin recovery within the process. This process, when performed in the laboratory, provided a starch that is contaminated with small dark pieces of hull which are difficult to remove from the starch.

Abrasive milling, using a small experimental tangential abrasive dehulling device (TADD) to remove the seed hull from quinoa seed that like Saponaria vaccaria contains both saponins and small granule starch is described by Reichert (Reichert et al 1986).

To date processes have not been developed in which both the secondary plant metabolites like saponins as well as the extremely small granule starch are recovered from Saponaria vaccaria seed on a commercial scale. Other species that are known to make relatively small sized starch granules include pseudocereals such as buckwheat, amaranth and quinoa and true cereals such as rice, oat and millet. However, no commercial scale starch extraction and bio-refinery process has been developed for any of these species.

### SUMMARY OF THE INVENTION

The present invention relates to the field of seed processing.

The present invention provides for methods pertaining to specialty milling of seed, and to obtaining starch, saponins, cyclopeptides, phenolics and fibre. A process is also provided to recover fine granule starch (<1.5 μm), protein as well as a seed extract enriched in saponins, cyclopeptides, phenolics and other bio-products from Saponaria vaccaria L.

It is an object of the invention to provide an improved method of seed processing.

According to the present invention there is provided a method to fractionate seed of Saponaria vaccaria by impact milling followed by the recovery of a perisperm fraction enriched in starch and a germ fraction enriched in oil, saponins and other secondary plant metabolites.

The present invention provides a method to fractionate Saponaria to obtain starch, protein, oil, saponins and secondary plant metabolites, comprising:
a) dry milling whole Saponaria seed using an impact mill, to obtain fractured seed
b) sieving the fractured seed to obtain a perisperm fraction enriched in starch, and a germ fraction enriched in oil, saponins and other secondary plant metabolites, and either:
   i) adding water to the perisperm fraction to obtain a crude starch slurry,
      sieving the crude starch slurry to remove the hull as a fibre fraction,
      increasing the pH of the crude starch slurry to solubilize the protein,
      separating the protein from the starch,
   ii) adding one or more than one solvent to the germ fraction, to produce an extracted germ fraction containing the protein and
      recovering the oil
      recovering a plant extract rich in the saponins and the secondary plant metabolites
   iii) or both i) and ii).

The method may be a continuous or a discontinuous process.

The present invention also pertains to the method described above, wherein prior to the step of dry milling the seed is tempered to a moisture content between about 8% to about 20%.

The present invention also pertains to the method described above, where in the step of increasing the pH of the crude starch slurry, the pH may be between about pH 9 to about pH 11.

The present invention also pertains to the method described above, where in the step of adding water, a liquid to solid ratio of water to the perisperm fraction may be 5 to 1.

The present invention also pertains to the method as described above, where in the step of separating, the protein is separated from the starch by centrifugation. The method to concentrate the protein may also be by acid precipitation or ultrafiltration.

The present invention pertains to the method as described above, wherein in the step of adding one or more than one solvent, the oil is extracted from the germ fraction using hexane.

The present invention pertains to the method as described above, wherein in the step of adding one or more than one solvent, the plant extract is extracted using aqueous ethanol or methanol.

The present invention describes the milling and subsequent wet extraction of a starch, protein, oil and seed extract from Saponaria vaccaria, a plant species that can be grown under standard agricultural production practices and harvested using conventional agricultural machinery.

The present invention overcomes limitations in the prior art by providing a method to fractionate seed and recover a small granule starch as well as additional fractions of biologically active plant extracts comprising saponins, and secondary plant metabolites such as cyclopeptides and phenolics. The process as developed can be implemented as a continuous process or a batch process to produce a range of bio-products from Saponaria vaccaria, which in this context meets the criteria of a bio-refinery.

The process for seed extraction developed for Saponaria vaccaria may also be applied to other crops that are characterized as having a small starch granule, or other seeds or grains that have a similar seed structure and morphology to Saponaria vaccaria; other seeds or grains having a similar composition as Saponaria vaccaria; and other seed or grains that contain saponins. Examples of such seed or grains include quinoa, amaranth, buckwheat, oats, rice and fenugreek.

This process provides a high quality white starch devoid of hull fragments, while protein, oil, fiber, saponins and other secondary plant metabolites can be recovered. The commercial viability and environmental responsibility of the process is enhanced through reduced processing times and decreased volumes of solvents. Reduced solvent volume was obtained by using an initial dry fractionation processing consisting of impact milling and sieving, followed by the further processing of the obtained fractions.

This summary of the invention does not necessarily describe all features of the invention.

### BRIEF DESCRIPTION OF THE DRAWINGS

These and other features of the invention will become more apparent from the following description in which reference is made to the appended drawings wherein:

FIG. 1 shows a schematic block diagram of an example of Saponaria vaccaria seed fractionation process.

FIG. 2 shows a schematic block diagram of an example of production of the starch and protein isolate from Saponaria vaccaria seed.

### DETAILED DESCRIPTION

The present invention relates to seed and grain processing.

The following description is of a preferred embodiment.

1. The present invention provides a method to fractionate Saponaria, for example but not limited to Saponaria vaccaria, seed to obtain starch, protein, saponins and other secondary plant metabolites, and oil. The method involves:
i) impact milling Saponaria vaccaria seed to produce a milled fraction;
ii) sieving the milled fraction to recover a perisperm fraction and a germ fraction; and either
iii) extracting starch and protein from the perisperm fraction using an aqueous medium, screening to separate hulls as a fibrous fraction from the starch and the protein, separating the starch and the protein by centrifugation, and recovering protein by concentrating and drying, recovering and drying the starch;
iv) extracting saponins, cyclopeptides, phenolics, oil and additional secondary plant metabolites from the germ fraction using a solvent, and
v) extracting starch and protein from the perisperm fraction using an aqueous medium, and extracting saponins, cyclopeptides, phenolics, oil and additional secondary plant metabolites from the germ fraction using a solvent.

The present invention also provides a process for refining Saponaria, for example but not limited to Saponaria vaccaria, seed comprising,
a) dry-milling whole Saponaria vaccaria seed to obtained fractured seed,
b) sieving the fracture seed to obtain a perisperm fraction comprising starch, protein and fibrous hull, and a germ fraction comprising oil, saponins and other secondary plant metabolites.
c) refining different compounds from the perisperm fraction and from the germ fraction by either;
i) adding water to the perisperm fraction to obtain a crude starch slurry,
   sieving the crude starch slurry to remove the hull,
   increasing the pH of the crude starch slurry to solubilize the protein,
   separating the protein from the starch,
ii) solvent extraction of the germ fraction, to produce an extracted germ fraction and to obtain
   an oil and a protein-enriched meal,
   a plant extract rich in saponins and other secondary plant metabolites, such as cyclopeptides and phenolics and a protein-enriched meal
iii) or both i) and ii).

Using the methods described herein, the present invention also provides a method to recover a substantially pure, for example, from about 70 to about 100% pure, any purity therebetween, for example 70-95% or any amount therebetween, or 70, 75, 80, 85, 90, 95, 100% pure, or any amount therebetween, small granule starch from a perisperm fraction.

Cyclopeptides are polypeptides with the amino and carboxyl termini joined forming a circular compound.

The germ is the embryo of the seed. Germ fraction is the fraction of the Saponaria vaccaria seed that consists primarily of germ (entire or fragments) with or without loose hull fragments. The germ fraction as prepared as described herein (by impact milling and screening) typically has a particle size smaller than 1 mm.

Retentate is the material that is retained in the screening process, while permeate is the material that passes through the screening process.

Perisperm is the nutritive starch containing tissue that is derived from the nucleus and is surrounded by the embryo of the seed. The perisperm fraction is a fraction that consists primarily of perisperm tissues, with some fragments of hull attached. The perisperm fraction of the Saponaria seed that is produced as described herein (by impact milling and screening) typically has a particle size greater than 1 mm.

Seed extract is the liquid, or solid after drying, that is rich in saponins, cyclopeptides and phenolics and that is produced from whole seed or a seed fraction, by extraction using a primary alcohol-water mixture.

Yield is the amount of a component recovered as a percentage of the amount present in the starting material (the germ fraction or the perisperm fraction).

The tissue used for recovery of saponins typically comprises seeds. However, roots, leaves, stems, seedlings, seed parts or mixtures thereof may also be used. The solvent used for the extraction may be any organic solvent which is capable of extracting, often by dissolving, the saponin compound of interest. Useful extraction solvents are methanol, ethanol, isopropyl alcohol, dichloromethane, chloroform, ethyl acetate, water, glycerol and mixtures thereof.

In order to recover high quality starch and a number of chemically diverse bio-products from Saponaria vaccaria seed, careful attention to milling strategy is required in order to ensure production of a high quality pure white starch, from a small dark hulled seed. Fine hull fragments contaminate starch preparations prepared from Saponaria vaccaria seed using prior art milling procedures (for example U.S. Pat. No. 3,622,389) and add an undesirable grey cast to the starch.

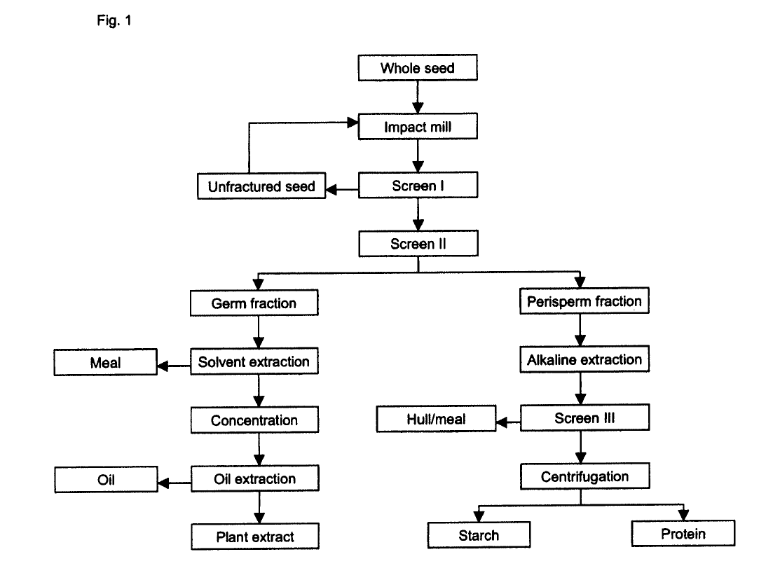

As described herein (See FIG. 1), milling Saponaria vaccaria seed by impact milling coupled with sieving produces a suitable starting material for further extraction and minimizes contamination of the starch fraction with dark hull fragments. In this procedure, whole mature Saponaria vaccaria seed, or tempered Saponaria vaccaria seed, is propelled at high velocity against a surface resulting in breakage of seed into pieces that are separated into fractions by sieving. A non-limiting example of an impact mill is an impact centrifugal mill (Type SER 14 S, Entoleter). The mill may be operated with a speed between about 1500 and about 4000 rpm, or any amount therebetween, for example, between 2000 rpm and about 3500 rpm, or any amount therebetween, from about 1500, 1750, 2000, 2200, 2400, 2500, 2600, 2750, 2800, 2900, 3000, 3100, 3200, 3300, 3400, 3500 rpm, or any amount therebetween, or at about 3300 rpm.

In order to optimize the breakage of the Saponaria vaccaria seed using the impact mill, the seed may be tempered prior to milling. In this procedure, water is added to the dry seed to bring it to the desired moisture content for example, from about 8% to about 18% moisture content or any amount therebetween, from about 10 to about 14% moisture content or any amount therebetween, about 8, 9, 10, 11, 12, 13, 14, 15, 16, 17, 18% moisture content or any amount therebetween, or a moisture content of about 12%. The seed moisture content may be determined using any suitable method, for example American Association of Cereal Chemists' Approved method 44-16 (2000). To temper seed, water is mixed with the seed and the wetted seed is equilibrated for 6 to 24 hours or any amount therebetween, for example 8 to 18 hours, or any amount therebetween, or 6, 8, 10, 12, 14, 16, 18, 20, 22, 24 hours, or any amount therebetween prior to milling to permit the water to diffuse into the seed.

From the material that passes through the mill, unbroken seed is separated by screening the material that comes out of the mill through a screen with a pore size between 1.5 and 2 mm, or any amount therebetween (Screen I), for example 1.5, 1.6, 1.7, 1.8, 1.9, 2.0 mm, or any amount therebetween. The milled seed can be fractionated into a perisperm fraction and a germ fraction by screening through a 0.3 to 1.5 mm screen (Screen II) (see FIG. 1). Screen exclusion sizes between about 0.3 mm and about 1.5 mm, or any size therebetween can be used for the second screening step, for example, a screen exclusion size of between about 0.6 and about 1.3 mm or any amount therebetween, a screen exclusion size of 0.3, 0.4, 0.5, 0.6, 0.7, 0.8, 0.9, 1.0, 1.1, 1.2, 1.3, 1.4, 1.5, or any amount therebetween, or a screen exclusion size of 1 mm. The perisperm fraction (typically greater than 1 mm) is rich in starch, some of the seed storage proteins and seed hull fragments that are still attached to perisperm tissues. The germ fraction, typically less than 1 mm, is rich in oil, saponins, cyclopeptides, phenolics, other secondary metabolites, residual seed storage proteins and seed hull fragments. Screening can be done using any of a variety of screening methods as would be known within the art, for example, a M2B all metal grain seed cleaner with automatic screen cleaning brushes (Ferrel Ross) may be used.

### Perisperm Fraction

The perisperm fraction obtained upon sieving is coarsely ground using for example, roller milling, hammer milling or other types of milling in order to improve the efficiency of starch and protein extraction. Roller milling has been found to be an effective milling method with the advantage that the material that is produced is fine enough for efficient starch extraction, but coarse enough to ensure that hull pieces can be removed by screening (FIGS. 1 & 2, Screen III). However, any milling method that avoids the hull pieces being finely ground may be used. A non-limiting example of a roller mill that may be used is a Sven grain mill (Apollo Machine and Products Ltd.). This mill may be fitted with two smooth rollers having a gap size between the rollers of about 0.3 mm to about 0.6 mm or any amount there between, for example a gap size of 0.3, 0.4, 0.5, 0.6 mm, for example, 0.4 mm.

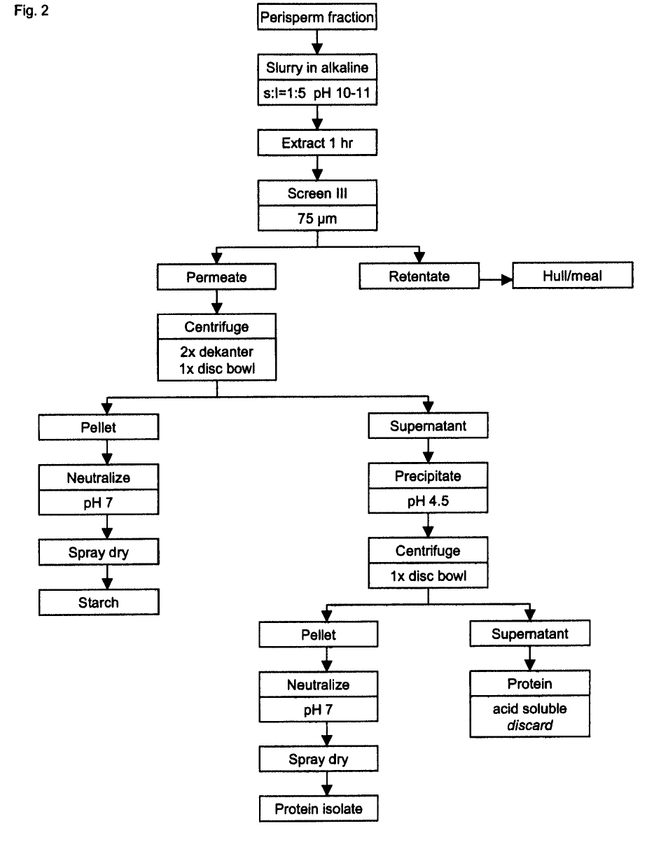

The coarse milled perisperm fraction is mixed with water to obtain a crude starch slurry (See FIG. 2). The crude starch slurry has a liquid to solid ratio between about 3 and about 20, or any amount therebetween, for example a liquid to solid ratio of about 3 to about 15 or any amount therebetween, about 4 to about 10 or any amount therebetween, a liquid to solid ratio of 3, 4, 5, 6, 7, 8, 9, 10, 11, 12, 13, 14, 15 or any amount there between, ideally a liquid to solid ratio of 5. The pH of the crude starch slurry may be adjusted, by addition of an appropriate base (e.g. NaOH or KOH) to promote protein solubility, without impacting the physical structure of starch granules, for example gelatinization of the starch granules. In order to ensure that the starch is not damaged, the pH is maintained at or below pH 12. To separate the protein from starch the pH of the crude starch slurry is adjusted between about pH 8 and about 12 or any pH therebetween, for example between about pH 9 and 11, or any pH therebetween, or pH 8, 9, 10, 11, 12 or any pH therebetween, or the crude starch slurry is adjusted to pH 10.

The pH adjusted crude starch slurry may be agitated for about 30 min to about 2 hours or any length of time therebetween, for example for about 45 min to about 1.5 hours, from about 30, 45, 60, 75, 90, 105, 120 min or any time therebetween, or for 1 hour. This agitation may loosen the starch from the coarse hull fraction and promote separation of starch, protein and hull fragments. The hull fraction can then be removed by a screening (Screen III, FIGS. 1&2). Several types of screening systems can be used for this screening process, for example a screw press or paddle press. An example is a Screen Separator 30″ (Sweco, Glorence, Ky., USA) fitted with three different screens. The pore size of the screen may be between about 20 and 425 μm or any size therebetween, for example between 50 and 200 μm, or any size therebetween, for example, a pore size of 45 μm. The dark fibrous hull impurities are removed as a retentate. The retentate can be dried and used as a fodder or feed supplement as well as a source of fiber. The dispersion of starch and protein is presented as in alkaline permeate.

The suspended starch granules are separated from the alkaline permeate by centrifugation or filtration. Several types of centrifugation or filtration systems can be used as known in the art, for example the centrifugation process can be continuous or carried out in batches. A continuous centrifugation system comprising a decanter centrifuge in series with a disc bowl centrifuge may be used. The seed proteins are dissolved in the aqueous phase of the alkaline permeate and are recovered in the supernatant following centrifugation, while the starch is collected as a pellet.

The concentrated dispersion of starch recovered by centrifugation or filtration, can be further processed to a high quality, free flowing, pure and white starch powder by neutralization (to a pH of about 6-8, for example pH 7), and drying, for example, by spray drying as described herein.

The concentrated dispersion of starch recovered by centrifugation or filtration can also be washed one or several times using water or aqueous alkaline to increase starch quality and purity. The concentrated dispersion of starch can be reslurried to liquid to solid ratio between about 3 and about 20, or any amount therebetween, for example a liquid to solid ratio of about 3 to about 15 or any amount therebetween, about 4 to about 10 or any amount therebetween, a liquid to solid ratio of 3, 4, 5, 6, 7, 8, 9, 10, 11, 12, 13, 14, 15 or any amount there between, for example a liquid to solid ratio of 5. The pH during this washing step may be adjusted, by addition of an appropriate base, for example but not limited to NaOH or KOH, to promote protein solubility, without impacting the physical structure of starch granules, for example gelatinization of the starch granules. In order to ensure that the starch is not damaged, the pH is maintained at or below pH 12. To separate the protein from starch the pH of the crude starch slurry is adjusted between about pH 8 and about 12 or any pH therebetween, for example between about pH 9 and 11, or any pH therebetween, or pH 8, 9, 10, 11, 12 or any pH therebetween, or the crude starch slurry is adjusted to pH 10. Per wash the mixture can be agitated for about 10 min to about 2 hours or any length of time therebetween, for example for about 45 min to about 1.5 hours, from about 10, 20, 30, 45, 60, 75, 90, 105, 120 min or any time therebetween, or for 1 hour.

The protein may be recovered from the one or more than one supernatant for example by precipitation, ultra-filtration or other concentrating steps. For example, the supernatant may be acidified to a pH of about 4 or pH 5 (Iso-electric precipitation), or heated, and subjected to a second centrifugation. The pellet may be washed, neutralized if desired to a pH of about 6-8, for example pH 7, and dried. Different methods of concentration of the protein will lead to slightly different properties of the final protein isolate. The use of iso-electric precipitation is described in the examples herein. The protein fraction can be dried with or without neutralization to pH 7 using drying methods known in the art. Spray drying after neutralization is described herein.

### Germ Fraction

The germ fraction obtained following the first screening step is typically less than 1 mm. Hull fragments present in the germ fraction can be removed by air classification. This fraction is extracted to obtain a saponin-enriched seed extract that contains in addition to saponins other secondary plant metabolites such as cyclopeptides and phenolics, Saponaria vaccaria oil and a protein-rich meal.

The first solvent for extracting the germ fraction may comprise a primary alcohol and water. The primary alcohol may be ethanol, methanol, n-propanol, iso-propanol, or a mixture thereof. A methanol:water extraction mixture is described herein. The methanol concentration in such mixture can be between about 50% (v/v) and about 90% (v/v) methanol, or any amount therebetween, between about 60% (v/v) and about 80% (v/v) methanol or any amount therebetween, 50, 52, 54, 56, 58, 60, 62, 64, 66, 68, 70, 72, 74, 76, 78, 80 methanol or any amount therebetween, or 70% (v/v) methanol. Similar amount of primary alcohol:water mixtures may be used if other primary alcohols are used.

The extraction can be conducted in various ways as known to a person skilled in the art. For example the germ fraction can be flaked using a flaking or roller mill prior to extraction to increase extraction efficiency. The germ fraction can also be used directly without flaking and extracted for example using an Innoweld extractor (Model Digmaz 50). The extraction can be either in a batch method or by a continuous process. The extraction temperature can range between 20° C. and 80° C. or any temperature therebetween, for example, 20, 22, 24, 26, 28, 30, 32, 34, 36, 38, 40, 42, 44, 46, 48, 50, 52, 54, 56, 58, 60, 62, 64, 66, 68, 70, 72, 74, 76, 78, 80° C., or any amount therebetween, or 60° C. as described herein.

Saponaria vaccaria seed oil can be recovered prior to the extraction of additional components including saponins, cyclopeptides or phenolics. Seed oil extraction can be conducted using the germ fraction. Alternatively, the seed oil can be extracted from the seed extract that is enriched in saponins, cyclopeptides and phenolics. The seed oil can be extracted using a solvent for example, petroleum ether, hexane or an equivalent solvent, using methods that are known in the art. For example mixing with warm solvent in a 1 to 5 solid to liquid ratio for several hours, recovering the defatted germ fraction by filtration. Recovering the seed lipids from the solvent fraction by distillation. The use of hexane is described herein.

The seed extract that is obtained from the germ fraction upon extraction with a primary alcohol in water comprises saponins, cyclopeptides and phenolics. Small water-soluble molecules may be removed from this fraction using dialysis. A step of dialysis may also concentrate the components within this fraction. The seed extract may be further concentrated by rotary-evaporation and dried using spray-drying or other ways of drying known in the art. The final product is a light yellow or light brown powder.

The seed extract prepared as described above typically contains saponins in a concentration between about 10 to about 80% saponins, or any amount therebetween, for example, from about 40 to about 60% saponins, or any amount therebetween, 10, 15, 20, 25, 30, 35, 40, 45, 50, 55, 60, 65, 70, 75, 80% saponins, or any amount therebetween. Other compounds, including phenolics, cyclopeptides and proteins are also present in the Saponaria vaccaria seed extract.

The seed extract may be incorporated into a solvent for specific applications. For example for use in as a cosmetic ingredient the extract may be incorporated in a 1:1 w/w mixture of 1,3 butylene glycol in water, which can be used in creams and lotions as a functional and/or active ingredient.

The present invention will be further illustrated in the following examples.

### EXAMPLES

The described processing methods can be extended to additional materials including: other seeds or grains containing small or extremely small granule starch; other seeds or grains that have a similar seed structure and morphology to Saponaria vaccaria; other seeds or grains having a similar composition as Saponaria vaccaria; and other seed or grains that contain saponins. Examples of such seed or grains are quinoa, amaranth, buckwheat, oats, rice and fenugreek.

### Example 1

### Fractionation of Saponaria vaccaria Seed by Impact Milling

Saponaria vaccaria seed was harvested mechanically from field grown plants and cleaned by screening and air classification to remove debris and any foreign seeds.

The seed was tempered to a seed moisture content of 12% for 18 hours. The tempered whole seed was milled using an impact mill (Type SER 14 S, Entoleter) at a mill speed of 3260 rpm.

Non-fractured seed was recovered by screening using a screen with a pore size of 1.7 mm. Any material larger than 1.7 mm is intact whole seed which is re-fed through the mill, while the fractured seed passes through the screen. The fractured seed is further screened through a 1 mm screen. The fraction with a particle size larger than 1 mm contains primarily the starch rich perisperm with attached hull fragments. The fraction with a particle size smaller than 1 mm is predominantly whole and fractured germ as well as loose hull material.

The whole seed fractionation process results in recovery of 65% (w/w) of the whole seed as the perisperm fraction, and 35% (w/w) of the whole seed as a germ fraction. The perisperm fraction comprises approximately 64% starch, 10% protein and 1% saponins. The germ fraction comprises approximately 23% protein, 19% starch, 7.5% saponins and 5.5% oil. Starch content was determined according to Approved methods of the American Association of Cereal Chemists (10^{th} Ed. St. Paul Minn.) method 76-13. The protein contents was determined using a FP-528 protein/nitrogen analyzer (LECO, St. Joseph, Mich.) according to Approved methods of the American Association of Cereal Chemists (2000, 10^{th} Ed. St. Paul Minn.) method 46-30. Oil content was determined using the Official Methods of Analysis of the AOAC (18^{th} Ed, 2005) method 2-93. Saponin content was determined with the method as described by Balsevich et al (2006) using HPLC-MS-PAD analysis with an internal standard of 10 μg/mL digitoxin.

### Example 2

### Preparation of Saponaria vaccaria Starch from the Perisperm Fraction on a Laboratory Scale

200 mL 0.03% sodium hydroxide solution was added to 40 g of the perisperm fraction (as provided in Example 1) and stirred for one hour at medium speed. The pH was adjusted to pH 10 using concentrated sodium hydroxide. The resultant material was passed though a US standard screen No. 500 (25 μm pore size) and the retentate discarded. The permeate was centrifuged at 4000 rpm (1252 g) for 10 minutes in a basket centrifuge (Model 5810R, Eppendorf). The supernatant containing the solubilized protein was discarded. The starch pellet was dispersed in 200 mL water, brought to pH 7 using concentrated hydrochloric acid and centrifuged at 4000 rpm (1252 g) for an additional 10 minutes. The supernatant was discarded. The starch pellet was dispersed in 100 mL 95% ethanol and centrifuged at 4000 rpm (1252 g) for 10 minutes. The supernatant was discarded and the starch was air dried.

Approximately 20 grams of final product was recovered that contained 98% starch as determined using the Approved methods of the American Association of Cereal Chemists (10^{th} Ed. St. Paul Minn.) method 76-13, and less than 1% protein as was determined using a FP-528 protein/nitrogen analyzer (LECO, St. Joseph, Mich.) according to Approved methods of the American Association of Cereal Chemists (2000, 10^{th} Ed. St. Paul Minn.) method 46-30.

### Example 3

### Preparation of Saponaria vaccaria Seed Extract from the Germ Fraction on a Laboratory Scale

A 60 gram sample of the germ fraction was extracted with 300 mL of 70% (v/v) methanol in water at a temperature of 60° C. in three steps of an hour each. The extraction was done in a waterbath and the sample was shaken vigorously every 15 minutes. After the first extraction interval the sample was centrifuged for 15 minutes at 4000 rpm (1252 g). The supernatant was poured off and 300 mL of fresh solvent (70% v/v methanol in water) was added to the pellet.

The pellet was extracted at a temperature of 60° C. in a waterbath and the sample was shaken vigorously every 15 minutes. After the second extraction interval the sample was centrifuged for 15 minutes at 4000 rpm (1252 g). The supernatant was poured off and combined with the supernatant of the first extraction step.

A third 300 mL of fresh solvent (70% v/v methanol in water) was added to the pellet. The pellet was extracted at a temperature of 60° C. in a waterbath and the sample was shaken vigorously every 15 minutes. After the third extraction interval the sample was centrifuged for 15 minutes at 4000 rpm (1252 g). The supernatant was poured off and combined with the supernatant of the first and second extraction steps.

The combined supernatant was allowed to dry down in the fume hood overnight after which it was reduced to a powder by freeze drying using a Super Modulyo Freeze Dryer (Thermo Fisher Scientific Inc.) at 60° C. at <10⁻¹ mbar for 24 hours. The resulting light yellow powder constitutes the primary seed extract.

A total of 6.9 g of seed extract was recovered that contained 50% saponins, 17% protein, 4.5% oil, and no starch. Saponin content was determined as described by Balsevich et al. (2006) using HPLC-MS-PAD analysis with an internal standard of 10 μg/mL digitoxin. The protein content was determined using a FP-528 protein/nitrogen analyzer (LECO, St. Joseph, Mich.) according to Approved methods of the American Association of Cereal Chemists (2000, 10^{th} Ed. St. Paul Minn.) method 46-30. Oil content was determined using the Official Methods of Analysis of the AOAC (18^{th} Ed, 2005) method nr 2-93. Starch content was determined according to Approved methods of the American Association of Cereal Chemists (10^{th} Ed. St. Paul Minn.) method 76-13.

### Example 4

### Preparation of Saponaria vaccaria Starch and Protein Isolate from the Perisperm Fraction on a Pilot Scale

100 kg of perisperm fraction (as provided in Example 1) was dispersed in 500 L of water, with or without the incorporation of a low concentration of a silica based anti-foaming agent containing polymethylsilaxane Inclusion of the anti-foaming agent increased the final starch yield two fold. The starch and protein slurry was brought to pH 10 using concentrated sodium hydroxide. The slurry was stirred for 1 hr.

Subsequently, the slurry was pumped into a Screen Separator 30 filtration system (Sweco) equipped with two screens, the top screen having 75 μm pores and the bottom screen having 45 μm pores. The retentate was recovered and dried to provide a fibrous meal/hull fraction.

The permeate was fed twice through a decanter centrifuge (Model CA22, Westfalia) and a solid (starch) pellet fraction, and a liquid (protein/starch) supernatant fraction were obtained. The liquid fraction was fed through a disk stack centrifuge (Model 7-06-076, Westfalia) to further separate the starch and protein. The pellets from both centrifuges comprising starch, were liquid enough to be combined, and were brought to pH 7 using concentrated hydrochloric acid. The neutralized starch sludge was spray dried (Pilot spray dryer, Model PSD55, APV Anhydro AS).

The supernatant was titrated to pH 4.5 using concentrated hydrochloric acid followed by a second centrifugation step using a disk stack centrifuge (Model 7-06-076, Westfalia) to separate the precipitated protein as a solid stream. The supernatant obtained from the second centrifugation step containing the acid soluble protein was discarded. The precipitated protein was neutralized using concentrated sodium hydroxide and spray dried (Pilot spray dryer, Model PSD55, APV Anhydro AS).

The starch yield was approximately 75% of total perisperm starch on a w/w basis. The recovered starch product contained 98% starch and less than 1% protein.

The protein yield was approximately 70% of total perisperm protein. The recovered protein product contained 70% (on a dry basis) protein. Protein and starch content were determined as described in previous examples.

### Example 5

### Preparation Saponaria vaccaria Seed Extract from a Germ Fraction on a Pilot Scale

A total of 22 kg of germ was placed into the 50 L sample vessel of the DIG-MAZ 150 extraction system with integrated distillation (Innoweld Extraktion Technik). 70 L of methanol and 30 L of water were added to the solvent vessel. The temperature of the solvent vessel was set to 57° C., and the vacuum pressure to 200 mbar.

Solvent was moved from the solvent tank to the sample tank in the first full extraction cycle. In total three full cycles were completed. The first full extraction cycle consisted of pumping solvent through the sample in steps of 10 minutes each, with two counter current (bottom to top) and two direct current (top to bottom) steps performed, for a total first full cycle time of 40 minutes. Upon completion of the first full cycle, all of the extraction solvent, containing the extracted metabolites, was removed from the 50 L sample vessel and returned to the solvent vessel. The extract liquid was then heated to 55-59° C., under 450 to 525 mbar of vacuum, to generate a fresh alcohol water mixture in the condenser of the extraction system. The extracted metabolites remained in the solvent vessel. When the condenser was full (approximately 15 L), the recovered solvent was pumped into the 50 L sample vessel. This process was repeated until enough fresh solvent was generated to fill the 50 L sample vessel and the second full extraction cycle was started.

In the second full extraction cycle the solvent was cycled through the sample bed for 40 minutes. Upon completion of the second full cycle, all of the extraction solvent, containing the extracted metabolites, was removed from the 50 L sample vessel and returned to the solvent vessel. The extract liquid was then heated to 55-59° C., under 450 to 525 mbar of vacuum, to generate a fresh alcohol water mixture in the condenser of the extraction system. The extracted metabolites remained in the solvent vessel. When the condenser was full (approximately 15 L), the recovered solvent was pumped into the 50 L sample vessel. This process was repeated until enough fresh solvent was generated to fill the 50 L sample vessel and the third full extraction cycle was started.

In the third full extraction cycle the solvent was cycled through the sample bed for 40 minutes. Upon completion of the third full cycle, all of the extraction solvent, containing the extracted secondary plant metabolites, was removed from the 50 L sample vessel and returned to the solvent vessel. The extract liquid was then heated to 55-59° C., under 450 to 525 mbar of vacuum, to generate a fresh alcohol water mixture in the condenser of the extraction system. By this means the extract in the solvent vessel was reduced to 25.1 kg.

The 25.1 kg of extract from the solvent vessel of the extractor was further concentrated in a 200 L Rotavapor® R250 (Büchi Labortechnik AG). A vacuum of 750-825 mbar and a temperature of 58-59° C. were used for this concentration phase and the extract was concentrated from 25.1 kg to 4.8 kg.

The concentrated extract was then dried using a Super Modulyo Freeze Drier (Thermo Fisher Scientific Inc.) at 60° C. at <10⁻¹ mbar for 24 hours. 4.8 kg of concentrated extract was reduced to 2.2 kg of seed extract.

The lipids from the 2.2 kg seed extract above were recovered in three steps each step consisting of adding 2 L of hexane to the extract, stirring 15 minutes in a stainless steel container, settling for 1 hour, decanting the hexane and centrifuging for 15 minutes at 4000 rpm (1252 g) to remove the remaining petroleum ether as supernatant. The hexane from the three extraction steps that now contains the seed lipids, was combined. The solvent in this lipid fraction was removed using a Rotavapor® R-210/R-215 (Büchi Labortechnik AG). 27.1 grams of lipids were recovered from the 2.2 kg of seed extract.

The saponin yield was approximately 95% of total germ saponins on a w/w basis. The recovered seed extract contained 70% saponins, 17% protein, 8% moisture, 1.6% phenolic compounds, 1% cyclopeptides, 1% oil (remaining lipids) and no starch. Saponin and cyclopeptide contents were determined as described by Balsevich et al. (2006) using HPLC-MS-PAD analysis with an internal standard of 10 μg/mL digitoxin. The protein content was determined using a FP-528 protein/nitrogen analyzer (LECO, St. Joseph, Mich.) according to Approved methods of the American Association of Cereal Chemists (2000, 10^{th} Ed. St. Paul Minn.) method 46-30. Moisture content was determined according to American Association of Cereal Chemists (2000, 10^{th} Ed. St. Paul Minn.) method 44-40. The amount of phenolic compounds was determined using the method of Ainsworth and Gillespie (2007). Oil content was determined using the Official Methods of Analysis of the AOAC (18^{th} Ed, 2005) method 2-93. Starch content was determined according to Approved methods of the American Association of Cereal Chemists (10^{th} Ed. St. Paul Minn.) method 76-13.

All citations are hereby incorporated by reference.

The present invention has been described with regard to one or more embodiments. However, it will be apparent to persons skilled in the art that a number of variations and modifications can be made without departing from the scope of the invention as defined in the claims.

### REFERENCES

Ainsworth E. A., Gillespie K. M. 2007. Estimation of total phenolic content and other oxidation substrates in plant tissues using Folin-Ciocalteu reagent. Nature Protocols, 2: 875-877.
Balsevich, J. J. et al 2006. Analysis of bisdesmosidic saponins in Saponaria vaccaria L. by HPLC-PAD-MS: identification of new quillaic acid and gypsogenin 3-O-Trisaccharides. Phytochem. Anal. 17: 414-423.
Biliaderis, C. G. et al 1993. Composition and physicochemical properties of starch from cow cockle (Saponaria vaccaria L.) seeds. Starch 45:121-127.
Demeke, T. et al 1999 Biochemical characterization of the wheat waxy a protein and its effect on starch properties. Cereal Chem. 76: 694-698.
Esch, F. van 1991. The efficiency of hydrocyclones for the separation of different starches. Starch 43: 427-431.
Francis, G. et al 2002. The biological action of saponins in animal systems: a review. Brit. J. Nutrition. 88:587-605.
Goering, K. J. et al 1965. New Starches; I. The unusual properties of the starch from Saponaria vaccaria. Cereal Chem 43: 127-136.
Juliano, B. O. 1984. Rice starch: production, properties and uses. In: Starch Chemistry and Technology. R. L. Whistler, J. N. BeMiller and E. F. Parschall (Eds.) Academic Press Inc., London, UK: 507-525.
Knight, J. W. et al 1984. Wheat starch: production, modification and uses. In: Starch Chemistry and Technology. R. L. Whistler, J. N. BeMiller and E. F. Parschall (Eds.) Academic Press Inc., London, UK: 491-505.
Lindeboom, N. et al 2004. Analytical, biochemical and physiochemical aspects of starch granule size, with emphasis on small granule starches: a review. Starch 56: 89-99.
Mazza, G. C. et al 1992. Compositional and morphological characteristics of cow cockle (Saponaria vaccaria) seed, a potential alternative crop. J Agic Food Chem 40: 1520-1523.
Morita, H. et al 2006. Structure of a new cyclic nonapeptide, segetalin F, and vasorelaxant activity of segatalins from Vaccaria segetalis. Bioorganic & Medicinal Chemistry Letters 16: 4458-61
Oda, K. et al 2004. Adjuvant and haemolytic activities of 47 saponins derived from medicinal and food plants. Biol Chem. 381:67-74.
Reichert, R. D. et al 1986. Abrasive dehulling of quinoa (Chenopodium quinoa): Effect on saponin content as determined by an adapted hemolytic assay. Cereal chem. 63: 471-475.
Sparg, S. G. et al 2004. Biological activities and distribution of plant saponins. J. Ethnopharmacology 94:219-43, (2004).
Tian, J. K. et al 2006 New cytotoxic saponins from Lysimachia davurica Ledeb. J Integrative Plant Biology 48:232-235.

What is claimed is:

1. A method for refining Saponaria vaccaria seed comprising,
a) dry-milling whole Saponaria seed to obtained fractured seed,
b) sieving the fracture seed to obtain a perisperm fraction comprising starch, protein and hull, and a germ fraction comprising oil, and protein enriched meal, and either:
i) adding water to the perisperm fraction to obtain a crude starch slurry,
sieving the crude starch slurry to remove the hull,
increasing the pH of the crude starch slurry to solubilize the protein,
separating the protein from the starch,
ii) solvent extracting the germ fraction, to produce an extracted germ fraction and
recovering the oil, protein and enriched meal from the extracted germ fraction,
iii) or both i) and ii).

2. The method of claim 1, wherein the process for refining is a continuous process.

3. The method of claim 1, wherein in the step of dry-milling, the mill is an impact mill.

4. The method of claim 1, wherein prior to the step of dry-milling the seed is tempered to a moisture content between 8% and 20%.

5. The method of claim 1, wherein in the step of solvent extracting, the germ fraction is enriched in saponins, cyclopeptides, phenolics and oil.

7. The method of claim 1, wherein in the step of increasing, the pH of the crude starch slurry is between pH 9 and pH11.

8. The method of claim 1, wherein in the step of adding water, a liquid:solid ratio of water to the perisperm fraction is 5:1.

9. The method of claim 1, wherein in the step of separating, the protein is separated from the starch by centrifugation or ultrafiltration.

10. The method of claim 9, wherein the protein is concentrated by acid precipitation.

11. The method of claim 1, wherein in the step of solvent extracting, the oil is extracted from the germ fraction using hexane.

12. A method to fractionate Saponaria to obtain starch, protein, saponin and metabolites, and oil comprising:
i) impact milling Saponaria vaccaria seed to produce a milled fraction;
ii) sieving the milled fraction to recover a perisperm fraction and a germ fraction; and either
iii) extracting starch and protein from the perisperm fraction using an aqueous medium, screening to separate hulls from the starch and the protein, separating the starch and the protein by centrifugation, and recovering protein by concentrating and drying, recovering and drying the starch;
iv) extracting saponins, cyclopeptides, phenolics and oil from the germ fraction using a solvent; or
v) both iii) and iv).
